(19) United States
(12) Patent Application Publication
(10) Pub. No.: US 2006/0146544 A1
(43) Pub. Date: Jul. 6, 2006

(54) LED candle

(76) Inventor: Moses Kit Leung, Hong Kong SAR (CN)

Correspondence Address: ALIX YALE & RISTAS LLP, 750 MAIN STREET, SUITE 1400, HARTFORD, CT, 06103, US

(21) Appl. No.: 11/029,983

(22) Filed: Jan. 5, 2005

(51) Int. Cl. F21V 35/00

(52) U.S. Cl. 362/392

(57) ABSTRACT

An artificial candle has a casing, an electric power source, a light emitter fixed to the casing and receiving electric power from the power source, a translucent shroud illuminated internally by the light emitter, and an interacting magnet and solenoid causing movement of the shroud with respect to the light emitter so that light from the light source that emanates at the shroud simulates the flickering of a flame.

### BACKGROUND OF THE INVENTION

The present invention relates to artificial candles. More particularly, although not exclusively, the invention relates to an artificial candle comprising a number of intermittently illuminated LEDs and a moving translucent flame-shaped shroud surrounding the LEDs to simulate a flame.

### OBJECT OF THE INVENTION

It is an object of the present invention to provide an improved artificial candle in which a flickering flame is well simulate.

### DISCLOSURE OF THE INVENTION

There is disclosed herein an artificial candle, comprising:
a casing,
an electric power source,
a light emitter mounted to the casing and receiving electric power from the power source,
a translucent shroud illuminated internally by the light emitter, and
motive means causing multi-directional movement of the shroud so that light from the light source that emanates at the shroud simulates the flickering of a flame.

Preferably, the light emitter is fixed with respect to the casing.

Preferably, the light emitter emits light intermittently.

Preferably, the artificial candle comprises a further light emitter situated nearby the first mentioned light emitter.

Preferably, the shroud is mounted movably to the casing and has depending from it a magnet and wherein the motive means comprises a first solenoid located within the casing and magnetically interacting with the magnet to move the shroud in a first direction.

Preferably, the artificial candle further comprises a control circuit for intermittently energising the first solenoid.

Preferably, the artificial candle further comprises a second solenoid positioned nearby the first solenoid and energised intermittently by the control circuit to magnetically interacting with the magnet to move the shroud in a second direction different to the first direction.

There is further disclosed herein an artificial candle, comprising:
a casing,
an electric power source,
a light emitter fixed to the casing and receiving electric power from the power source,
a translucent shroud illuminated internally by the light emitter, and
motive means causing movement of the shroud with respect to the light emitter so that light from the light source that emanates at the shroud simulates the flickering of a flame.

Preferably, the light emitter emits light intermittently.

Preferably, a further light emitter is situated nearby the first mentioned light emitter.

Preferably, the shroud is mounted movably to the casing and has depending from it a magnet and wherein the motive means comprises a solenoid located within the casing and magnetically interacting with the magnet to move the shroud.

Preferable, the artificial candle further comprises a control circuit for intermittently energising the solenoid.

### BRIEF DESCRIPTION OF THE DRAWINGS

A preferred form of the present invention will now be described by way of example with reference to the accompanying drawings, wherein:

FIG. 1 is a schematic perspective illustration of an artificial candle,

FIG. 2 is another schematic perspective illustration of the artificial candle,

FIG. 3 is a schematic parts-exploded perspective illustration of the artificial candle's internal components,

FIG. 4 is a schematic parts-exploded perspective illustration of the candle's casing,

FIG. 5 is another schematic parts-exploded perspective illustration of the artificial candle's internal components,

FIG. 6 is another schematic parts-exploded perspective illustration of the candle's casing,

FIG. 7 is a schematic cross-sectional elevation of an upper portion of the artificial candle,

FIG. 8 is a schematic parts-exploded perspective illustration of the upper portion of the artificial candle, and

FIG. 9 is a schematic circuit diagram of a driver circuit located within the casing of the artificial candle.

### DESCRIPTION OF THE PREFERRED EMBODIMENT

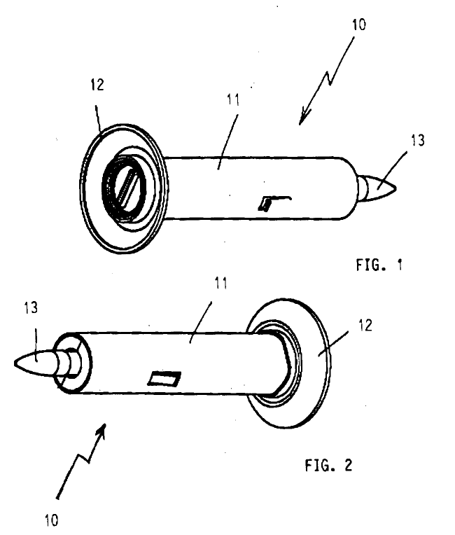

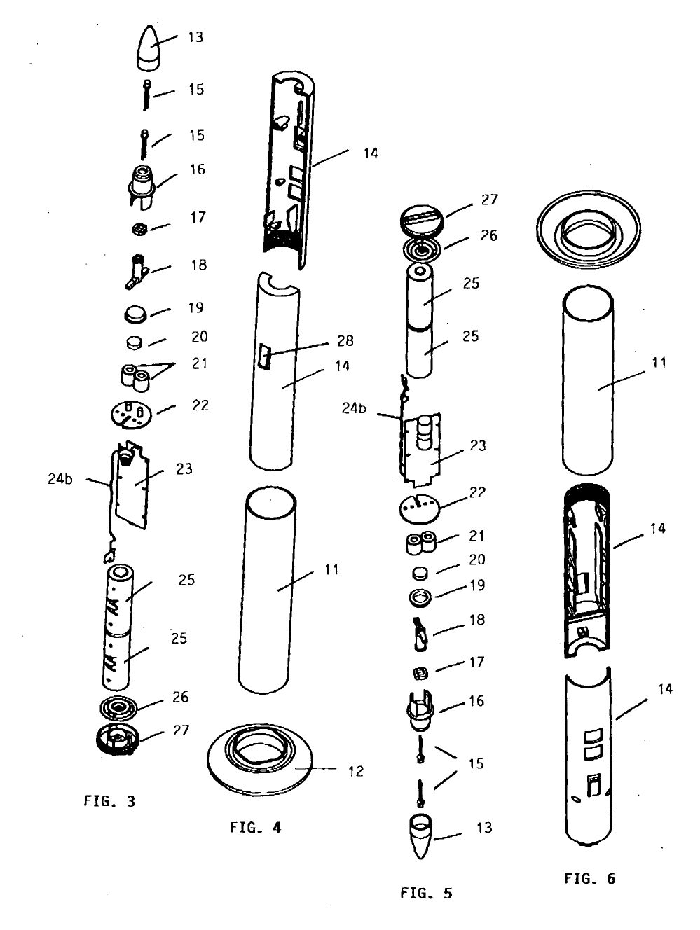

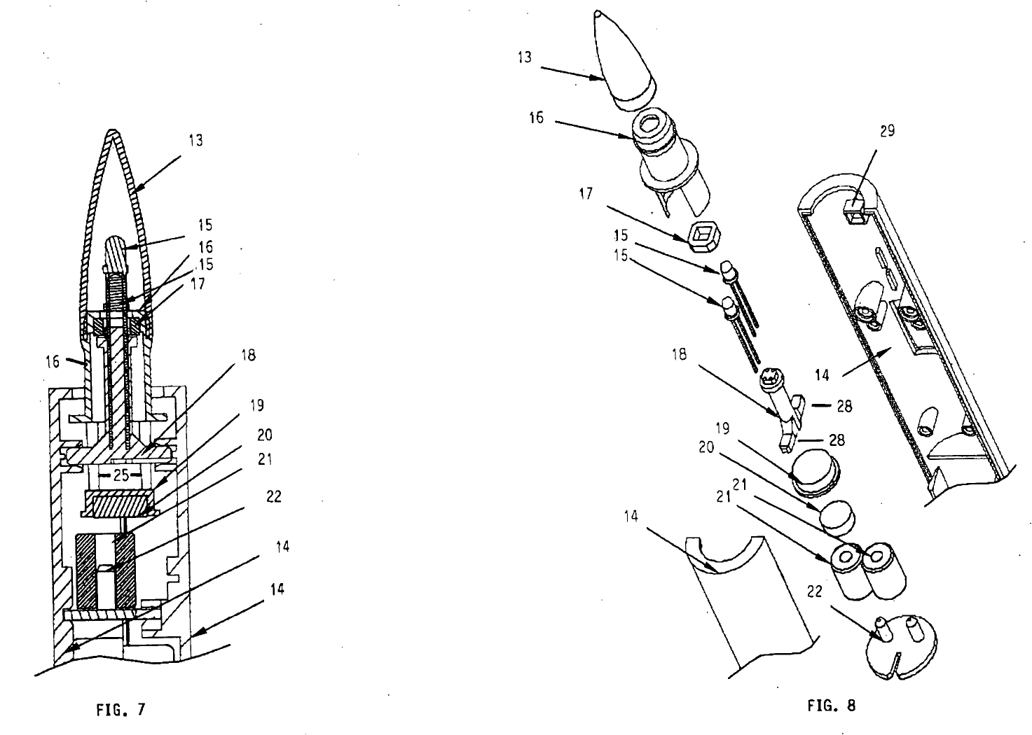

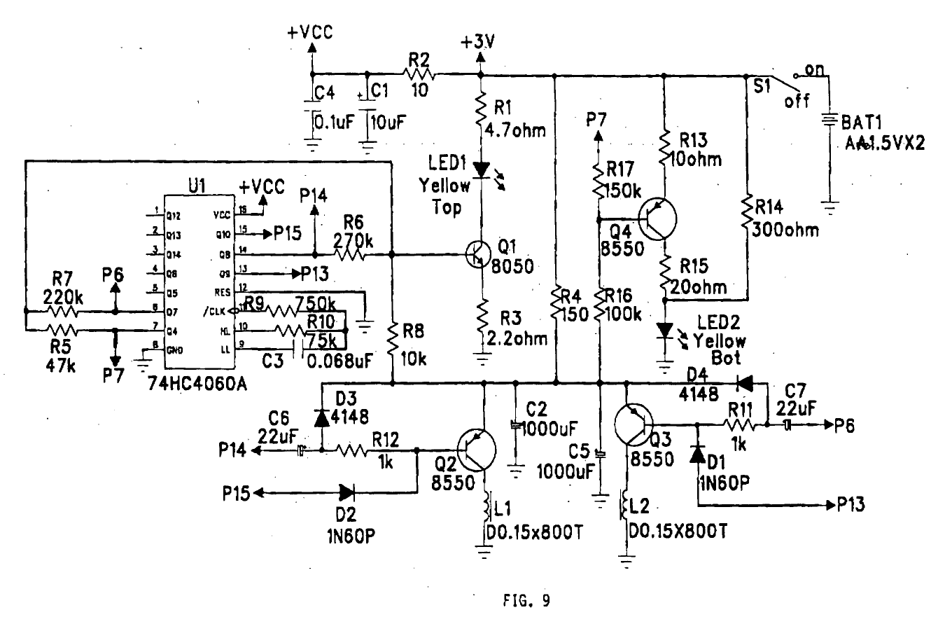

In FIGS. 1 to 8 of the accompanying drawings there is depicted schematically an artificial candle 10 comprising a base 12 on which there sits a plastics sleeve 11 preferably having a waxy appearance and/or texture. Within the sleeve there is a pair of casing halves 14. One of the casing halves 14 has a power switch 28 connected by a wire 24a to a PCB 23. A pair of batteries 25 resides between the casing halves 14 and delivers power to the PCB 23 via a wire 24b and the switch 28. There is a removable battery cover 27 adjacent to the base 12 and a conductive battery spring 26 located between the cover 27 and the lower-most battery 25 via which current is conducted to the PCB 23. The circuitry of FIG. 9 would be located upon the PCB 23.

Situated above the PCB 23 is a solenoid support plate 22 having a pair of upwardly extending posts onto each of which one of a pair of solenoids 21 is received. The solenoids 21 are individually electrically connected with the circuitry on the PCB 23. Each solenoid is angularly offset from the central longitudinal axis of the artificial candle. Preferably, the angular offset of one of the solenoids with respect to the longitudinal axis is at 90 degrees to the angular offset of the other solenoid.

At the top of the artificial candle there is a translucent flame-shaped shroud 13 made of plastics material and inside of which there is provided a pair of LEDs 15. The LEDs might radiate white light to an orange/flame coloured shroud, or the shroud might be white/translucent and the LEDs might radiate an orange/flame colour to radiate the colour of a flame through the translucent shroud. One of the LEDs is typically positioned higher than the other as shown.

The translucent shroud 13 is fitted upon a shroud holder 16. The shroud holder 16 might be made of clear plastics material so as to minimise its visual prominence.

The LEDs are mounted to an LED holder 18 which has a pair of diametrically opposed arms 28 fixed against rotation within respective support formations 29 at the inside surface of each casing half 14. At least one of the LEDs receives intermittent power from the PCB circuitry. One of the LEDs might receive constant power, or both LEDS might be powered intermittently to flicker on and off in unison or in alternating manner.

At the top of the LED holder, just beneath the LEDs, there is provided a suspension ring 17. The suspension ring surrounds the legs of the LEDs and might be made of resilient material such as rubber and serves to suspend the shroud holder 16 in a wobbly manner. Depending as part of the shroud holder 16 is a pair of legs 25 at the bottom of which there is provided a magnet holder 19 in the form of an inverted cup. There is a permanent magnet 20 fixed within the magnet holder 19.

Depending on the polarity of current delivered to the solenoids, they might induce attractive or repulsive magnetic forces upon the permanent magnet 20. The suspension ring 17 is approximately at the base of the shroud and broadly defines the pivot location of the shroud and shroud holder, simulating the point at which the base of the flame would extend from the wick of a real candle. Indeed the thin nature of the upstanding portion of the LED holder through which the LED legs extend would be provided with a white and/or black colour to mimic the appearance of a real wick. When the solenoids 20 are alternately or simultaneously energised in forward or reverse polarity, a magnetic field or interacting magnetic fields act on the permanent magnet 20 to cause jiggling movement of the shroud holder 16 and shroud 13 to simulate the flickering movement of a flame in a mild breeze. For example if just one of the solenoids is energised, the shroud will move in a first direction. If the other solenoid is energised, the shroud will move in a second direction perpendicular to the first direction. If both solenoids are energised simultaneously, the shroud will move in a direction that is at 45° to the first and second directions such that if the artificial candle is centred upon a dinner table for example, people sitting at any position around the table will see flickering movements of the shroud. Simultaneous reverse polarity energisation of the solenoids or mutually inverse energisation of the solenoids will provide more combinations of movements. Not only will the shroud move, but the emanation of light at the external surface of the shroud will shift due to the movement of the shroud with respect to the LEDs.

It should be appreciated that modifications and alterations obvious to those skilled in the art are not to be considered as beyond the scope of the present invention. For example, instead of providing a permanent magnet 20, a small piece of ferrous metal might be provided in which case the magnetic forces generated by the solenoids would only be attractive thereto and this might be sufficient, depending on the chosen positioning of the solenoids with respect thereto.

1. An artificial candle, comprising:
a casing,
an electric power source,
a light emitter mounted to the casing and receiving electric power from the power source,
a translucent shroud illuminated internally by the light emitter, and
motive means causing multi-directional movement of the shroud so that light from the light source that emanates at the shroud simulates the flickering of a flame.

2. The artificial candle of claim 1, wherein the light emitter is fixed with respect to the casing.

3. The artificial candle of claim 1, wherein the light emitter emits light intermittently.

4. The artificial candle of claim 3, comprising a further light emitter situated nearby the first mentioned light emitter.

5. The artificial candle of claim 1, wherein the shroud is mounted movably to the casing and has depending from it a magnet and wherein the motive means comprises a first solenoid located within the casing and magnetically interacting with the magnet to move the shroud in a first direction.

6. The artificial candle of claim 5, further comprising a control circuit for intermittently energising the first solenoid.

7. The artificial candle of claim 6, further comprising a second solenoid positioned nearby the first solenoid and energised intermittently by the control circuit to magnetically interacting with the magnet to move the shroud in a second direction different to the first direction.

8. An artificial candle, comprising:
a casing,
an electric power source,
a light emitter fixed to the casing and receiving electric power from the power source,
a translucent shroud illuminated internally by the light emitter, and
motive means causing movement of the shroud with respect to the light emitter so that light from the light source that emanates at the shroud simulates the flickering of a flame.

9. The artificial candle of claim 8, wherein the light emitter emits light intermittently.

10. The artificial candle of claim 9, comprising a further light emitter situated nearby the first mentioned light emitter.

11. The artificial candle of claim 8, wherein the shroud is mounted movably to the casing and has depending from it a magnet and wherein the motive means comprises a solenoid located within the casing and magnetically interacting with the magnet to move the shroud.

12. The artificial candle of claim 11, further comprising a control circuit for intermittently energising the solenoid.
